(19) United States
(12) Patent Application Publication
(10) Pub. No.: US 2026/0016691 A1
(43) Pub. Date: Jan. 15, 2026

(54) MULTILAYER WAVEGUIDE WITH MULTILAYER OUT-COUPLING GRATING

(71) Applicant: CORNING INCORPORATED, CORNING, NY (US)

(72) Inventor: Vladimir Nikolaevich Borisov, Helsinki (FI)

(21) Appl. No.: 19/243,316

(22) Filed: Jun. 19, 2025

Related U.S. Application Data
(60) Provisional application No. 63/669,426, filed on Jul. 10, 2024.

(51) Int. Cl. G02B 27/01; G02B 6/34

(52) U.S. Cl. CPC G02B 27/0101; G02B 6/34; G02B 2027/0118

(57) ABSTRACT

An optical element for augmented reality and other devices is described. The optical element includes a multilayer waveguide, an in-coupling element for directing imaging light into the multilayer waveguide, and an out-coupling element spaced apart from the in-coupling element for directing light out of the multilayer waveguide to form a virtual image in the viewing field of an observer. The out-coupling element is a diffractive optical element that includes two or more diffractive grating layers that differ in refractive index. Inclusion of multiple diffraction grating layers in the out-coupling element leads to an improvement in the brightness uniformity of virtual images produced by imaging light spanning a wide range of incidence angle.

This application claims the benefit of priority under 35 U.S.C. § 119 of U.S. Application Ser. No. 63/669,426 filed on Jul. 10, 2024, the content of which is relied upon and incorporated herein by reference in its entirety.

### FIELD

This description relates to optical elements for use in augmented reality devices. More particularly, this description relates to optical elements with multilayer waveguides designed to improve brightness uniformity at the exit pupil. Most particularly, this description relates to multilayer diffractive out-coupling elements for multilayer waveguides that act to minimize differences in the out-coupling efficiency of imaging light coupled into the waveguide at different angles of incidence.

### BACKGROUND

Augmented reality devices are gaining in consumer acceptance as the dimensions decrease and more socially acceptable form factors are developed. An augmented reality device generates a virtual image and superimposes it on the viewing field of an observer. The virtual image includes information that supplements, enhances, or interprets objects in the viewing field. A common design for augmented reality devices is based on a combination of optical elements that include imaging optics, a waveguide, and light-coupling elements. The imaging optics generate a virtual image and direct it to an in-coupling element. The in-coupling element couples the imaging light into the waveguide whereupon it is transmitted within the waveguide to an out-coupling element. The out-coupling element directs the imaging light to a specified location in the observer's field of view.

The in-coupling and out-coupling elements are refractive or diffractive optical elements designed, respectively, to couple light into and out of the waveguide. Refractive light-coupling optical elements include prisms. A diffractive light-coupling optical element typically includes a surface relief grating with diffractive features formed by nanoimprinting, or a holographic grating with volumetric diffractive features formed by single or multiple beam holographic recording. Both types of gratings consist of a single layer of a base material with the diffractive features formed thereon or therein.

Light provided by the imaging optics is typically non-collimated and approaches the in-coupling element as a series of components that span a range of incidence angles. Upon coupling into the waveguide by the in-coupling element, the range of incidence angles produces components of guided light in the waveguide that transmit over a range of propagation angles to the out-coupling element. The mechanism of propagation within the waveguide is total internal reflection. Depending on application requirements, single-layer waveguides or multilayer waveguides are used. Multilayer waveguides include two or more layers that differ in refractive index. To achieve a wide field of view, single-layer waveguides require high-index materials. High-index materials typically have high density and are disadvantageous in augmented reality applications because they increase the weight of optical elements. Multilayer waveguides offer opportunities for weight reduction of optical elements because they can be configured to include a combination of a thicker low density layer with low index and a thinner high-index, high density without compromising the field of view.

A drawback associated with multilayer waveguides is that the intensity of imaging light that propagates through the waveguide to the out-coupling element varies with the incidence angle of light to the in-coupling element. As a result, when the waveguide receives imaging light over a range of incidence angles, the intensity of light produced by the out-coupling element varies with incidence angle and results in a non-uniformity in the brightness of the virtual image perceived by an observer. The brightness non-uniformity distorts the virtual image and detracts from the quality of the augmented reality experience. It is accordingly desirable to develop optical elements with multilayer waveguides for augmented reality devices that improve the brightness uniformity of virtual images.

### SUMMARY

The present disclosure provides an optical element that can be used in augmented reality and other light guiding devices. The optical element includes a multilayer waveguide, an in-coupling element, and a diffractive out-coupling element. The in-coupling and out-coupling elements may be interfaced with or formed on a surface of the multilayer waveguide. Imaging light over a range of incidence angles is directed into the in-coupling element and coupled into the waveguide. The coupled light propagates within the waveguide by total internal reflection to the diffractive out-coupling element and is diffracted to the viewing field of a user of the device. The diffractive out-coupling element features two or more layers that differ in refractive index and is configured to include a variability in diffraction efficiency that acts to improve the uniformity in diffracted brightness of imaging light received at different angles of incidence at the in-coupling element.

The present disclosure extends to:

An optical element comprising
a waveguide, the waveguide comprising a first layer in contact with a substrate, the first layer having a first refractive index n_{532,1} and the substrate having a second refractive index n_{532,2}, the first refractive index n_{532,1} greater than the second refractive index n_{532,2};
a diffractive optical element in contact with the waveguide, the waveguide directing light to the diffractive optical element at a first propagation angle θ, the diffractive optical element comprising:
a first diffraction grating layer in contact with the first layer, the first diffraction grating layer having a third refractive index n_{532,3} and a first diffraction efficiency DE_{532,1} at the first propagation angle θ, the third refractive index n_{532,3} greater than the second refractive index n_{532,2};
a second diffraction grating layer in contact with the first diffraction grating layer, the second diffraction grating layer having a fourth refractive index n_{532,4} and a second diffraction efficiency DE_{532,2} at the first propagation angle θ, the fourth refractive index n_{532,4} less than the third refractive index n_{532,3}, the second diffraction efficiency DE_{532,2} greater than the first diffraction efficiency DE_{532,1}.

Additional features and advantages will be set forth in the detailed description which follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

The accompanying drawings are included to provide a further understanding, and are incorporated in and constitute a part of this specification. The drawings are illustrative of selected aspects of the present description, and together with the specification serve to explain principles and operation of methods, products, and compositions embraced by the present description. Features shown in the drawing are illustrative of selected embodiments of the present description and are not necessarily depicted in proper scale.

### BRIEF DESCRIPTION OF THE DRAWINGS

While the specification concludes with claims particularly pointing out and distinctly claiming the subject matter of the written description, it is believed that the specification will be better understood from the following written description when taken in conjunction with the accompanying drawings, wherein:

FIG. 1A depicts an optical element that includes a multilayer waveguide, an in-coupling element, and an out-coupling element.

FIG. 1B depicts the convention used to define the incidence angle α of imaging light into the in-coupling element of the optical element of FIG. 1A.

FIG. 2 depicts an angle of diffraction θ of imaging light diffracted into a high-index layer of a multilayer waveguide through a diffractive in-coupling element and an angle of refraction ω of light refracted from the high-index layer of the multilayer waveguide into a low-index layer of the multilayer waveguide.

FIG. 3 depicts the mode of transmission of imaging light from the in-coupling element to the out-coupling element of the optical element of FIG. 1A for imaging light entering at a low angle of incidence.

FIG. 4 depicts the mode of transmission of imaging light from the in-coupling element to the out-coupling element of the optical element of FIG. 1A for imaging light entering at a high angle of incidence.

FIG. 5 shows the variation of intensity of light entering the out-coupling element of the optical element of FIG. 1A as a function of the angle of incidence α and mode of transmission of imaging light.

FIG. 6 depicts the diffraction efficiency of a diffractive out-coupling element needed to equalize the intensity of light entering the out-coupling element of the optical element of FIG. 1A for the modes of transmission of imaging light depicted in FIGS. 3 and 4.

FIG. 7 depicts an optical element having an out-coupling element that includes a diffractive optical element with two or more diffraction grating layers that differ in refractive index.

FIG. 8 depicts the variation in diffraction efficiency with propagation angle for an embodiment of the optical element with the out-coupling element shown in FIG. 7.

FIG. 9 depicts the variation in diffraction efficiency with propagation angle for a comparative optical element that includes a single diffraction grating layer.

FIG. 10 depicts the variation in diffraction efficiency with propagation angle for a comparative optical element that includes a single diffraction grating layer.

FIG. 11 depicts the variation in diffraction efficiency with propagation angle for a comparative optical element that includes a single diffraction grating layer.

The embodiments set forth in the drawings are illustrative in nature and not intended to be limiting of the scope of the detailed description or claims. Whenever possible, the same reference numeral will be used throughout the drawings to refer to the same or like feature.

### DETAILED DESCRIPTION

The present disclosure is provided as an enabling teaching and can be understood more readily by reference to the following description, drawings, examples, and claims. To this end, those skilled in the relevant art will recognize and appreciate that many changes can be made to the various aspects of the embodiments described herein, while still obtaining the beneficial results. It will also be apparent that some of the desired benefits of the present embodiments can be obtained by selecting some of the features without utilizing other features. Accordingly, those who work in the art will recognize that many modifications and adaptations are possible and can even be desirable in certain circumstances and are a part of the present disclosure. Therefore, it is to be understood that this disclosure is not limited to the specific compositions, articles, devices, and methods disclosed unless otherwise specified. It is also to be understood that the terminology used herein is for the purpose of describing particular aspects only and is not intended to be limiting.

The present disclosure describes optical elements with multilayer waveguides that can be used in augmented reality and other light guiding devices. The optical elements include light-coupling elements; in particular, an in-coupling element and an out-coupling element. Light-coupling elements include diffractive optical elements (DOE). Diffractive optical elements include diffractive in-coupling elements, which diffract imaging light into the multilayer waveguide, and diffractive out-coupling elements, which diffract imaging light that propagates within the multilayer waveguide out of the multilayer waveguide. The optical elements may also include an expanding element, such as an exit pupil expander, which may also be a diffractive element. The expanding element may be integrated with or separate from a light-coupling element. Gratings for light-coupling and expanding elements include 1D gratings, 2D gratings, and holographic gratings. Diffractive in-coupling and out-coupling elements may be interfaced with or formed on a surface of the waveguide. Diffractive in-coupling and out-coupling elements may be integrated into or onto a surface of the waveguide. Imaging light is directed to an in-coupling grating and diffracted by the in-coupling grating into the multilayer waveguide. The diffracted light propagates within each layer of the multilayer waveguide to the out-coupling grating and is diffracted by the outcoupling grating to the viewing field of a user of the device.

The multilayer waveguide includes a high-index layer and a low-index layer. The out-coupling grating is a composite grating that includes a first layer with a refractive index that is the same as or similar to the refractive index of the high-index layer of the multilayer waveguide and a second layer with a refractive index that is the same as or similar to the refractive index of the low-index layer of the multilayer waveguide. The composite out-coupling grating improves the brightness uniformity of light diffracted from the multilayer waveguide to improve the quality of the virtual image perceived by the user of the optical element.

Disclosed are components (including materials, compounds, compositions, and method steps) that can be used for, in conjunction with, in preparation for, or as embodiments of the disclosed reflecting optical elements and methods for making reflecting optical elements. It is understood that when combinations or subsets, interactions of the components are disclosed, each component individually and each combination of two or more components is also contemplated and disclosed herein even if not explicitly stated. If, for example, if a combination of components A, B, and C is disclosed, then each of A, B, and C is individually disclosed as is each of the combinations A-B, B-C, A-C, and A-B-C. Similarly, if components D, E, and F are individually disclosed, then each combination D-E, E-F, D-F, and D-E-F is also disclosed. This concept applies to all aspects of this disclosure including, but not limited to, components corresponding to materials, compounds, compositions, and steps in methods.

In this specification and in the claims which follow, reference will be made to a number of terms which shall be defined to have the following meanings:

“Include,” “includes,” or like terms means encompassing but not limited to, that is, inclusive and not exclusive.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions.

As used herein, contact refers to direct contact or indirect contact. Direct contact refers to contact in the absence of an intervening material and indirect contact refers to contact through one or more intervening materials. Elements in direct contact touch each other. Elements in indirect contact do not touch each other, but are otherwise joined to each other through one or more intervening materials. Elements in contact may be rigidly or non-rigidly joined. Contacting refers to placing two elements in direct or indirect contact. Elements in direct (indirect) contact may be said to directly (indirectly) contact each other.

The construction and arrangement of the elements of the present disclosure, as shown in the exemplary embodiments, is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel and nonobvious teachings and advantages of the subject matter recited. For example, elements shown as integrally formed may be constructed of multiple parts, or elements shown as multiple parts may be integrally formed, the operation of the interfaces may be reversed or otherwise varied, the length or width of the structures, and/or members, or connectors, or other elements of the system, may be varied, and the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

The indefinite article “a” or “an” and its corresponding definite article “the” as used herein means at least one, or one or more, unless specified otherwise.

The term “n₅₃₂” refers to refractive index at a wavelength of 532 nm. The term “n_{532,i}”, where i=1, 2, 3, . . . , refers to the refractive index of component i of a multicomponent optical element. If an optical element includes a first layer and a second layer, for example, the term “n_{532,1}” refers to the refractive index at 532 nm of the first layer and the term “n_{532,2}” refers to the refractive index at 532 nm of the second layer.

Diffraction efficiency (DE) is defined as the ratio of the first-order diffracted intensity from a diffraction grating to the intensity of light incident to the diffraction grating. The values of diffraction efficiency (DE) reported herein correspond to diffraction efficiency (DE) of light having a wavelength of 532 nm and are designated by the term “DE₅₃₂”. The term “DE_{532,i}”, where i=1, 2, 3, . . . , refers to the diffraction efficiency at 532 nm of diffractive layer i of an optical element that includes multiple diffractive layers. If an optical element includes a first diffractive layer and a second diffractive layer, for example, the term “DE_{532,1}” refers to the diffraction efficiency at 532 nm of the first diffractive layer and the term “DE_{532,2}” refers to the diffraction efficiency at 532 nm of the second diffractive layer.

The claims as set forth below are incorporated into and constitute part of this Detailed Description.

Reference will now be made in detail to illustrative embodiments of the present description.

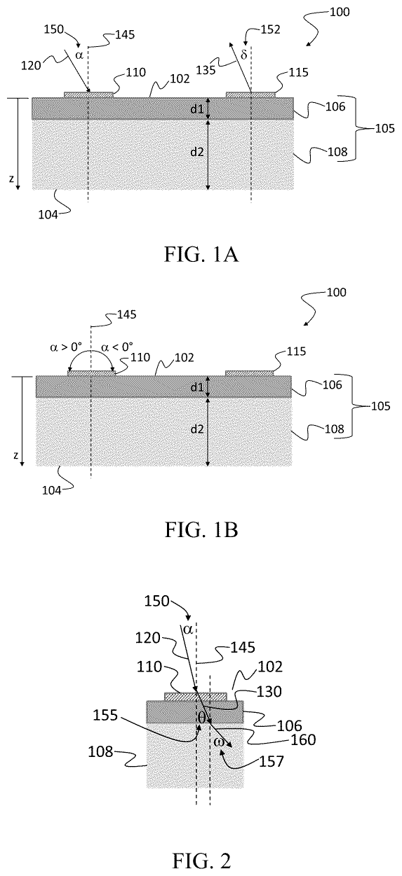

FIG. 1A shows an optical element 100 in cross-section. Optical element 100 includes waveguide 105, in-coupling grating 110 and out-coupling grating 115. Waveguide 105 includes high-index layer 106 and low-index layer 108. In-coupling grating 110 and out-coupling grating 115 are diffractive light-coupling elements disposed on or within incidence surface 102 of waveguide 105. Waveguide 105 further includes back surface 104. Incidence surface 102 is the surface of waveguide 105 upon which imaging light 120 is incident and back surface 104 opposes incidence surface 102. Waveguide 105 has a thickness direction z, where the coordinate z defining the thickness direction has a value of zero at the incidence surface 102 and increases in the direction toward back surface 104. Thickness refers to the smallest linear dimension describing the shape of waveguide 105 (or high-index layer 106 or low-index layer 108) (e.g., the smallest of length, width, and height for a planar waveguide, or the smaller of diameter and height for a cylindrical or disk-shaped waveguide). High-index layer 106 has a thickness d1 and low-index layer 108 has a thickness d2.

In operation, waveguide 105 receives imaging light 120 at in-coupling grating 110. In-coupling grating 110 diffracts the imaging light 120 into high-index layer 106 of waveguide 105. The imaging light propagates within waveguide 105 by total internal reflection to out-coupling grating 115, which diffracts the imaging light out of waveguide 105. Shown in FIG. 1A is a component of imaging light 120 that approaches incidence surface 102 at an angle of incidence α (depicted at 150) relative to normal 145 to incidence surface 102. For purposes of the present disclosure, the incidence angle α is defined relative to normal 145 such that imaging light 120 incident to in-coupling grating 110 in the direction of normal 145 has incidence angle α=0° and the range of incidence angles α extends from −90° (direction parallel to incidence surface 102 that extends from in-coupling grating 110 toward out-coupling grating 115) to 90° (direction parallel to incidence surface 102 that extends from in-coupling grating 110 away from out-coupling grating 115). FIG. 1B shows the distinction between positive (0°<α≤90°) and negative (−90°≤α<0°) incidence angles α. By way of example, the incidence angle α shown in FIG. 1A is positive. The depicted component of imaging light 120 is diffracted by incoupling grating 110 to form a component of diffracted light 130 having an angle of propagation θ (depicted at 155 in FIG. 2) in high-index layer 106 of waveguide 105. As discussed more fully below and depending on the incidence angle α, a further refraction of diffracted light 130 to form refracted light 160 that enters low-index layer 108 of waveguide 105 at a refraction angle ω (depicted at 157 in FIG. 2) may occur.

Imaging light 120 representing a virtual image is provided by an imager (typically consisting of a microdisplay and optics) (not shown). Imaging light 120 is monochromatic or polychromatic. Imaging light 120 preferably includes one or more wavelengths between 400 nm and 700 nm, such as, for example, red, green, and/or blue light. The imaging light 120 is directed to an in-coupling grating 110, which diffracts the imaging light 120 into high-index layer 106 of waveguide 105. Diffracted light 130 is monochromatic or polychromatic. Diffracted light 130 transmits internally within waveguide 105 by total internal reflection and reaches out-coupling grating 115. Out-coupling grating 115 diffracts the transmitted light out of waveguide 105 as output light 135 at diffraction angle δ (depicted at 152), which is directed to a viewer. Output light 135 is monochromatic or polychromatic.

Although not depicted explicitly in the schematic of FIGS. 1A and 1B, it is understood in the art that imaging light 120 includes multiple components that approach incidence surface 102 over a range of incidence angles α. The range of incidence angles α extends from a minimum incidence angle αₘᵢₙ to a maximum incidence angle αₘₐₓ. The multiple components of imaging light 120 are diffracted by in-coupling grating 110 to form multiple components of diffracted light 130 that are transmitted over a range of propagation angles θ. The range of propagation angles θ extends from a minimum propagation angle θₘᵢₙ to a maximum propagation angle θₘₐₓ.

Selection of the imager and its operation to provide a desired virtual image controls the distribution of incidence angle α for the components of imaging light 120. In principle, the incidence angle α can range from −90° to 90°. In various embodiments, the absolute value of the incidence angle α ranges from 5° to 85°, or from 5° to 70°, or from 5° to 55°, or from 5° to 40°, or from 5° to 25°, or from 10° to 80°, or from 10° to 70°, or from 10° to 55°, or from 10° to 40°, or from 10° to 25°, or from 15° to 75°, or from 15° to 70°, or from 15° to 55°, or from 15° to 40°, or from 15° to 25°, or from 20° to 70°, or from 25° to 65°, or from 30° to 60°, or from 35° to 55°. The minimum absolute value of the incidence angle αₘᵢₙ is greater than or equal to 5°, or greater than or equal to 10°, or greater than or equal to 15°, or greater than or equal to 20°, or greater than or equal to 25°, or greater than or equal to 30°, or greater than or equal to 35°, or less than or equal to 50°, or less than or equal to 45°, or less than or equal to 40°, or in the range from 5° to 50°, or in the range from 10° to 45°, or in the range from 15° to 40°, or in the range from 20° to 35°. The maximum absolute value of the incidence angle αₘₐₓ is greater than or equal to 50°, or greater than or equal to 55°, or greater than or equal to 60°, or greater than or equal to 65°, or greater than or equal to 70°, or greater than or equal to 75°, or greater than or equal to 80°, or less than or equal to 90°, or less than or equal to 70°, or less than or equal to 60°, or less than or equal to 50°, or less than or equal to 30°, or less than or equal to 20°, or in the range from 10° to 50°, or in the range from 10° to 40°, or in the range from 10° to 30°, or in the range from 50° to 90°, or in the range from 55° to 85°, or in the range from 60° to 80°.

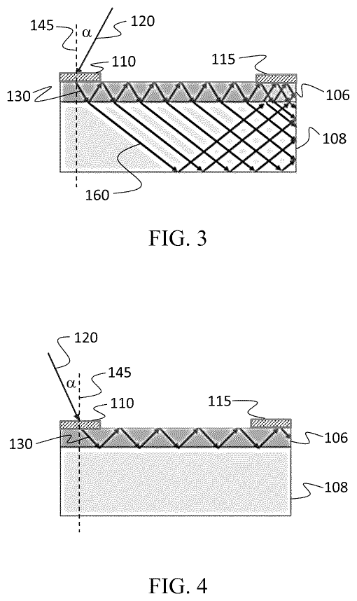

Due to the conditions governing total internal reflection, the mode of transmission of imaging light 120 through waveguide 105 depends on the incidence angle α (FIGS. 3 and 4). FIG. 3 shows transmission of a component of imaging light 120 that has an incidence angle α that is large and negative. In this situation, in-coupling grating 110 diffracts the component of imaging light 120 to form a component of diffracted light 130 in high-index layer 106 that then partially refracts at the interface of high-index layer 106 and low-index layer 108 to form a component of refracted light 160 that enters low-index layer 108. Refracted light 160 propagates by total internal reflection within low-index layer 108. As the incidence angle α of imagining light 120 increases (becomes less negative or positive), refraction of diffracted light 130 into low-index layer 108 ceases and transmission of imaging light 120 to out-coupling grating 115 occurs exclusively by propagation of diffracted light 130 by total internal reflection in high-index layer 106 (FIG. 4).

The angular range defined by the field of view can be resolved into separate intervals of incidence angle based on the mode of transmission. The angular range of incidence angles α extending from the minimum incidence angle αₘᵢₙ to the maximum incidence angle αₘₐₓ can be subdivided into a first interval of incidence angles extending from the minimum incidence angle αₘᵢₙ to a first intermediate incidence angle α₁ and a second interval of incidence angles extending from a second intermediate incidence angle α₂ to the maximum incidence angle αₘₐₓ, where the mode of transmission in the first and second intervals of incidence angle differ. In one embodiment, imaging light in the first interval of incidence angle is transmitted by the mode of transmission depicted in FIG. 3 and imaging light in the second interval of incidence angle is transmitted by the mode of transmission depicted in FIG. 4.

Because of the difference in mode of transmission, the intensity of light entering out-coupling grating 115 varies with incidence angle α. The intensity of light diffracted by out-coupling grating 115 accordingly varies with incidence angle α, which leads to non-uniformity in the brightness of the virtual image produced by optical element 100.

In the mode of transmission depicted in FIG. 3, imaging light 120 entering in-coupling grating 110 transmits in waveguide 105 by total internal reflection through both high-index layer 106 (depicted as diffracted light 130) and low-index layer 108 (depicted as refracted light 160). Much of the intensity of refracted light 160, however, fails to enter out-coupling grating 115 due to total internal reflection of refracted light 160 in low-index layer 108. Reflection of refracted light 160 at the interface between high-index layer 106 and low-index layer 108 means that the portion of imaging light 120 that refracts into low-index layer 108 is unable to return with appreciable intensity to high-index layer 106. The intensity of imaging light 120 that enters out-coupling grating 115 is instead primarily limited to the portion transmitted through high-index layer 108. In effect, refracted light 160 represents a loss in the mode of transmission depicted in FIG. 3 that diminishes the intensity of light ultimately diffracted by out-coupling grating 115. A virtual image with lower brightness accordingly results over incidence angles α for which the mode of transmission depicted in FIG. 3 is operable. When the portion of imaging light 120 that refracts into low-index layer 108 from high-index layer 106 is minimized or eliminated, as depicted in the mode of transmission shown in FIG. 4, the intensity of imaging light 120 diffracted by out-coupling grating 115 is increased and a virtual image with higher brightness results.

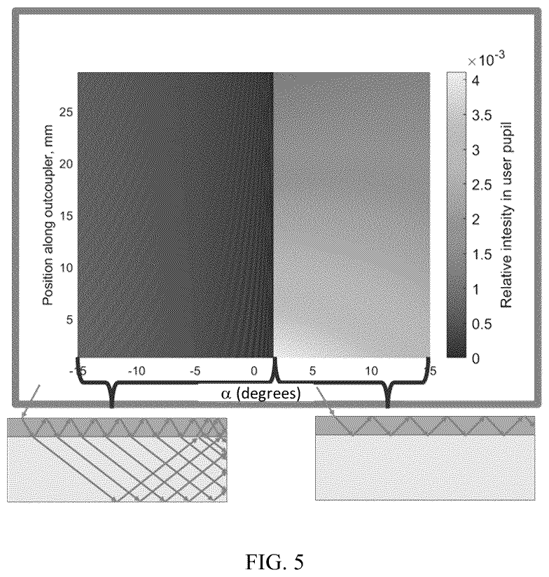

The angle of incidence a defining the transition from the mode of transmission depicted in FIG. 3 to the mode of transmission depicted in FIG. 4 depends on the indices and thicknesses of low-index layer 106 and high-index layer 108. By way of example, FIG. 5 shows results of a calculation of the relative intensity of monochromatic light (532 nm) diffracted by the out-coupling grating of a representative optical element of the type shown in FIG. 1A. The representative optical element included a waveguide with a high-index layer 108 with index n₅₃₂=2.00 and thickness d1=0.1 mm, and a low index layer 106 with index n₅₃₂=1.50 and thickness d2=0.5 mm. In-coupling grating 110 and out-coupling grating 115 were configured as surface relief gratings with a grating spacing of 361.67 nm. The length of in-coupling grating 110 was 2.5 mm, the length of out-coupling grating 115 was 30 mm, and the edge-to-edge spacing between the closest edges of in-coupling grating 110 and out-coupling grating 115 was 30 mm. FIG. 5 shows relative intensity of light diffracted by out-coupling grating 115 as a function of position (in units of mm, with position increasing in the direction away from in-coupling grating 110) along out-coupling grating 115 and incidence angle α. Relative diffracted intensity is shown in grayscale where lighter coloring corresponds to higher intensity of light diffracted by out-coupling grating 115. The minimum relative diffracted intensity shown in FIG. 5 is 6.0×10⁻¹⁵ and the maximum relative diffracted intensity shown in FIG. 5 is 4.1×10⁻³. The ratio of maximum relative diffracted intensity to minimum relative diffracted intensity is 6.8×10¹¹. As seen in FIG. 5, the intensity of light diffracted by out-coupling grating 115 is higher for larger values of incidence angle α and lower for smaller values of incidence angle α. The ranges of incidence angle α associated with the modes of transmission depicted in FIGS. 3 and 4 are also shown. The transition from the mode of transmission depicted in FIG. 3 to the mode of transmission depicted in FIG. 4 occurs at an incidence angle α of about 1.5°. The sharp demarcation between the two modes of transmission is vividly evident in FIG. 5.

The variation with incidence angle α in the intensity of imaging light 120 diffracted by out-coupling grating 115 shown in FIG. 5 results in a non-uniformity in the brightness of the virtual image produced by the optical element when a conventional (single-layer) out-coupling grating is utilized. To remedy the non-uniformity in brightness and progress toward virtual images with uniform brightness over a wide range of incidence angle α, the present disclosure describes an improved out-coupling grating that provides variability in diffraction efficiency that counteracts variability in the intensity of light otherwise diffracted by the out-coupling grating. More specifically, the out-coupling grating described herein provide higher diffraction efficiency for components of imaging light 120 with incidence angle α in a range governed by the mode of transmission depicted in FIG. 3 and lower diffraction efficiency for components of imaging light 120 with incidence angle α in a range governed by the mode of transmission depicted in FIG. 4. Out-coupling gratings featuring variability of diffraction efficiency (DE) with incidence angle α improve brightness uniformity relative to single-layer out-coupling gratings that exhibit a constant or approximately constant diffraction efficiency (DE).

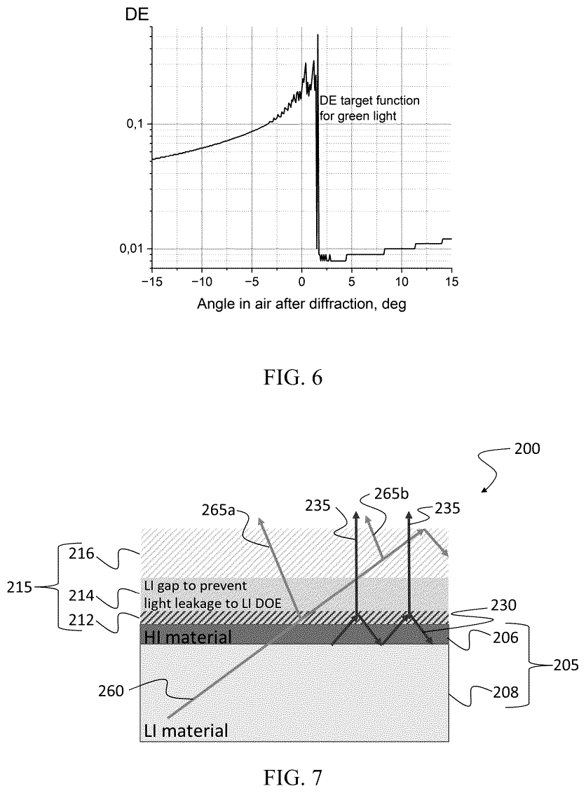

FIG. 6 shows a diffraction efficiency (DE₅₃₂) profile (for 532 nm (green) light) that would compensate the brightness non-uniformity associated with the example depicted in FIG. 5. The diffraction efficiency profile shows diffraction efficiency (DE₅₃₂) as a function of the diffraction angle δ (depicted at 152) of output light 135 from out-coupling grating 115. The diffraction efficiency (DE₅₃₂) profile shown in FIG. 6 corresponds to one position along the out-coupling grating 115. In practical implementation, the entire length of out-coupling grating 115 would be configured to have the diffraction efficiency (DE₅₃₂) profile of FIG. 6 (or, in some embodiments, a modified form thereof adjusted to account for position-dependent differences, if any, in the brightness of the virtual image produced by out-coupling grating 115).

The diffraction angle δ of a component of light is related to the angle of the component of light as it enters out-coupling grating 115 through the grating equation, where the angle at which a component of light enters out-coupling grating 115 correlates with incidence angle α. Negative diffraction angles δ correlate with negative incidence angles α and positive diffraction angles δ correlate with positive incidence angles α. As seen in FIG. 6, the diffraction efficiency (DE₅₃₂) is high for small positive and negative diffraction angles δ (corresponding to the small positive and negative incidence angles α associated with the mode of transmission depicted in FIG. 3) and low for larger positive diffraction angles δ (corresponding to the larger positive incidence angles α associated with the mode of transmission depicted in FIG. 4).

A noteworthy feature of the diffraction efficiency profile (DE₅₃₂) of FIG. 6 is the sharp change in diffraction efficiency (DE₅₃₂) at the diffraction angle δ corresponding to the transition from the mode of transmission depicted in FIG. 3 to the mode of transmission depicted in FIG. 4. A change in diffraction efficiency (DE₅₃₂) of more than an order of magnitude over a range of diffraction angle δ of a few degrees is needed to equalize the brightness of virtual images provided by the different modes of transmission depicted in FIGS. 3 and 4. In the embodiment of FIG. 6, for example, the peak diffraction efficiency (DE₅₃₂) in the range of diffraction angle δ associated with the mode of transmission depicted in FIG. 3 is about 50% and occurs near the transition to the mode of transmission depicted in FIG. 4. At the transition to the mode of transmission depicted in FIG. 4, the diffraction efficiency (DE₅₃₂) decreases to about 0.7%. The transition occurs over a range of diffraction angle δ that is approximately 1°.

For purposes of the present disclosure, a discontinuous change in diffraction efficiency (DE₅₃₂) is defined as a change in diffraction efficiency (DE₅₃₂) greater than or equal to 5.0% over a range of diffraction angle δ less than 5.0°. In first embodiments, the out-coupling gratings of the present disclosure provide a change in diffraction efficiency (DE₅₃₂) greater than or equal to 5.0% over a range of diffraction angle δ less than 5.0°, or less than 4.0°, or less than 3.0°, or less than 2.5°, or less than 2.0°, or less than 1.5°, or less than 1.0°. In second embodiments, the out-coupling gratings of the present disclosure provide a change in diffraction efficiency (DE₅₃₂) greater than or equal to 10% over a range of diffraction angle δ less than 5.0°, or less than 4.0°, or less than 3.0°, or less than 2.5°, or less than 2.0°, or less than 1.5°, or less than 1.0°. In third embodiments, the out-coupling gratings of the present disclosure provide a change in diffraction efficiency (DE₅₃₂) greater than or equal to 20% over a range of diffraction angle δ less than 5.0°, or less than 4.0°, or less than 3.0°, or less than 2.5°, or less than 2.0°, or less than 1.5°, or less than 1.0°. In fourth embodiments, the out-coupling gratings of the present disclosure provide a change in diffraction efficiency (DE₅₃₂) greater than or equal to 30% over a range of diffraction angle δ less than 5.0°, or less than 4.0°, or less than 3.0°, or less than 2.5°, or less than 2.0°, or less than 1.5°, or less than 1.0°. In fifth embodiments, the out-coupling gratings of the present disclosure provide a change in diffraction efficiency (DE₅₃₂) greater than or equal to 40% over a range of diffraction angle δ less than 5.0°, or less than 4.0°, or less than 3.0°, or less than 2.5°, or less than 2.0°, or less than 1.5°, or less than 1.0°. In sixth embodiments, the out-coupling gratings of the present disclosure provide a change in diffraction efficiency (DE₅₃₂) greater than or equal to 50% over a range of diffraction angle δ less than 5.0°, or less than 4.0°, or less than 3.0°, or less than 2.5°, or less than 2.0°, or less than 1.5°, or less than 1.0°.

While single-layer out-coupling gratings may be adequate for achieving relatively uniform brightness of virtual images in optical elements based on single-layer waveguides, they are inadequate for compensating for the large difference in brightness in optical elements based on two-layer waveguides that arise from the two different modes of transmission that occur over the range of incidence angles α provided by the source of imaging light. The present out-coupling gratings, in contrast, can be configured to provide discontinuous changes in diffraction efficiency (DE₅₃₂) that better enable brightness uniformity over wide ranges of incidence angle of the imaging light.

The out-coupling gratings of the present disclosure include two or more diffraction grating layers, where each diffraction grating layer is a single layer that includes diffractive features defining a diffraction grating (e.g. surface relief features, holographic features). Each diffraction grating layer is independently configured and/or the combination of diffraction grating layers is arranged to diffract light guided by different modes of transmission in waveguide 105 with different diffraction efficiency (DE₅₃₂). The refractive index n₅₃₂ differs for the different diffraction grating layers. Preferably, the diffractive index n₅₃₂ of each diffraction grating layer matches or is similar to the refractive index n₅₃₂ of a different one of the layers of the multi-layer waveguide. The brightness of light diffracted from the present multi-layer out-coupling grating is more uniform with respect to incidence angle α than is possible from a single-layer out-coupling grating when used with a multi-layer waveguide.

FIG. 7 illustrates an embodiment and principle of operation of a multi-layer out-coupling grating. Optical element 200 includes waveguide 205 and diffractive optical element 215. Waveguide 205 includes high-index layer 206 and low-index layer 208. Diffractive optical element 215 includes high-index diffraction grating layer 212 and low-index diffraction grating layer 216. High-index diffraction grating layer 212 has a lower diffraction efficiency than low-index diffraction grating layer 216. Diffractive optical element 215 optionally includes a low-index spacer layer 214 without diffractive features to provide physical separation between high-index diffraction grating layer 212 and low-index diffraction grating layer 216.

Diffractive optical element 215 functions as an out-coupling grating and the portion of optical element 200 depicted in FIG. 7 is the portion in the vicinity of the out-coupling grating. Optical element 200 further includes an in-coupling grating (not shown) as described above in connection with FIGS. 1A, 1B, and 2. The in-coupling grating receives imaging light 120 and couples it into waveguide 205. The mode of transmission of light guided in waveguide 205 depends on the incidence angle α as described above in connection with FIGS. 3 and 4. At low incidence angles α, the mode of transmission is as depicted in FIG. 3. More specifically, a portion light coupled into waveguide 205 from the in-coupling grating is guided by total internal reflection as diffracted light 230 within high-index layer 206 and a portion of light coupled into waveguide 205 from the in-coupling grating refracts at the interface of high-index layer 206 and low-index layer 208 and is guided as refracted light 260 in low-index layer 208. At high incidence angles α, the mode of transmission is as depicted in FIG. 4 and the in-coupling grating provides diffracted light 230 that is guided by total internal reflection within high-index layer 206 without refraction into low-index layer 208.

FIG. 7 illustrates interaction of diffracted light 230 and refracted light 260 with diffractive optical element 215. Diffracted light 230 is guided within high-index layer 206 of waveguide 205 and is diffracted as output light 235 by high-index diffraction grating layer 212. The reduction in refractive index n₅₃₂ at the interface of high-index diffraction grating layer 212 and low-index diffraction grating layer 216 (or low-index spacer layer 214) acts to confine the non-diffracted portion of diffracted light 230 within high-index layer 206 and inhibits (or prevents) transmission of diffracted light 230 into low-index diffraction grating layer 216 (or low-index spacer layer 214). Instead, the portion of diffracted light 230 not diffracted by high-index diffraction grating layer 212 remains subject to conditions of total internal reflection within high-index layer 206.

Refracted light 260 approaches diffractive optical element 215 from within low-index layer 208 of waveguide 205. A portion of refracted light 260 passes through high-index layer 206, enters high-index diffraction grating layer 212, and is diffracted with low diffraction efficiency as output light 265a. Refracted light 260 is not subject to conditions of total internal reflection within high-index layer 206 of waveguide 205 so the portion of refracted light 260 transmitted into high-index layer 206 that is not diffracted by high-index diffraction grating layer 212 transmits to low-index diffraction grating layer 216 (directly or via optional low-index spacer layer 214) and is further diffracted with high diffraction efficiency as output light 265b. Low-index diffraction grating layer 216 harvests and diffracts with high efficiency (as output light 265b) a portion of refracted light 260 that, in the absence of low-index diffraction grating layer 216, would be lost. The net effect of diffractive optical element 215 is an increase in diffraction efficiency of light guided in waveguide 205 by the mode of transmission depicted in FIG. 3 and an approach toward equalization of the intensity of output light over the full range of incidence angles α. A virtual image with greater uniformity in brightness results.

FIG. 8 shows modelled diffraction efficiency (DE₅₃₂) as a function of propagation angle θ for an embodiment of the optical element 200 shown in FIG. 7. The length of in-coupling grating 110 (not shown in FIG. 7) was 2.5 mm, the length of out-coupling grating 215 was 30 mm, and the edge-to-edge spacing between the closest edges of in-coupling grating 110 and out-coupling grating 215 was 30 mm. In-coupling grating 110 and each diffraction grating layer of out-coupling grating 215 was configured as a surface relief grating with a grating spacing of 361.67 nm. In the embodiment, optical element included waveguide 205 with high-index layer 206 (n_{532,1}=2.0, thickness d₁=0.1 mm) in direct contact with low-index layer 208 (n_{532,2}=1.5, thickness d₂=0.5 mm). High-index diffraction grating layer 212 (n_{532,3}=2.0, thickness d₃=30 nm) directly contacts high-index layer 206. A low-index spacer layer 214 (n_{532,4}=1.5, thickness d₄=500 nm) directly contacts high-index diffraction grating layer 212. Low-index diffraction grating layer 216 (n_{532,5}=1.5, thickness d₅=250 nm) directly contacts low-index spacer layer 214. In the modeling, a fill factor of 0.5 was assumed for both high-index diffraction grating layer 212 and low-index diffraction grating layer 216 and a phase shift of 0° was assumed for high-index diffraction grating layer 212 and low-index diffraction grating layer 216.

FIG. 8 shows a discontinuity (marked with a vertical dashed line) in diffraction efficiency (DE₅₃₂) at a propagation angle θ of about 46.5°, which corresponds to the transition from the mode of transmission depicted in FIG. 3 (propagation angle θ<46.5°, where light propagates (is guided) in both low-index (LI) layer 208 and high-index (HI) layer 206)) to the mode of transmission depicted in FIG. 4 (propagation angle θ>46.5°, where light propagates (is guided) only in high-index (HI) layer 206). The diffraction efficiency changes from about 13% (0.13 on the scale of FIG. 8)) at a propagation angle θ of 45.5° to about 0.6% (0.006 on the scale of FIG. 8) at propagation angle θ of 47.0°. The ratio of diffraction efficiency (DE₅₃₂) for the two modes of transmission (13%/0.6%=21.7) represents a factor by which brightness uniformity is potentially enhanced when using the two-layer diffractive optical element of this embodiment.

The diffractive optical elements of the present disclosure are capable of providing large changes in diffraction efficiency (DE₅₃₂) with incidence angle α, including the discontinuous changes as described above. In other embodiments, the change in diffraction efficiency (DE₅₃₂) is large but not discontinuous. Embodiments of the diffractive optical elements of the present disclosure include two layers that differ in refractive index n₅₃₂ and diffraction efficiency (DE₅₃₂), where the absolute value of the difference between the diffraction efficiency (DE₅₃₂) of the two layers is greater than 2%, or greater than 5%, or greater than 10%, or greater than 15%, or greater than 20%, or greater than 25%, or greater than 30%, or in the range from 2% to 50%, or in the range from 5% to 40%, or in the range from 10% to 30%.

Strategies for controlling the diffraction efficiency (DE₅₃₂) of low-index diffraction grating layer 216 and high-index diffraction grating layer 212 are known in the art and depend on the configuration of the diffraction grating. Typically, an increase in the phase contrast associated with diffractive features of the diffraction grating leads to an increase in diffraction efficiency. Phase contrast can be varied through control of the physical dimensions or composition of the diffractive features. Grating efficiency is also influenced by the alignment of diffractive features in low-index diffraction grating layer 216 and high-index diffraction grating layer 212. Each diffraction grating layer includes diffractive features arranged periodically with a grating spacing defining the period. The grating spacing may be the same or different for low-index diffraction grating layer 216 and high-index diffraction grating layer 212. When the grating spacing is the same, the periods of low-index diffraction grating layer 216 and high-index diffraction grating layer 212 may be aligned (in registry) or unaligned (out of registry or staggered by up to half of the grating spacing). The state of alignment introduces a phase shift that influences diffraction efficiency.

Various types of diffraction gratings are known and compatible with the optical element of the present disclosure. Types of diffraction gratings include surface relief gratings, metasurfaces, volumetric gratings (e.g., volumetric Bragg gratings).

Surface relief gratings and metasurfaces can be made directly in the waveguide material or made from different material(s) located on the waveguide surface or a combination thereof. Surface relief gratings can have a binary form, staircase (stepwise) form, sinusoidal form, triangular form, trapezoid form, blazed form, slanted form, or any other geometric form. Metasurfaces can have a shape-optimized profile, double-ridge profile, block-and-pillar profile, or other geometric form. Surface relief gratings and metasurfaces can be made by nanoimprinting, etching (dry, chemical, e-beam), mechanical cutting, electrical poling, vapor deposition, nanolithography, or other suitable production technique.

Diffractive features of surface relief gratings and metasurfaces are based on textured or corrugated surfaces that include peaks and valleys. Strategies for controlling the diffraction efficiency of surface relief gratings and metasurfaces include varying the height (peak-to-valley separation), tilt (blaze angle, which is the angle relative to surface normal) or fill factor (ratio of width to period spacing) of the diffractive features. Within limits known in the art, diffraction efficiency increases with an increase in height, tilt or fill factor of the diffractive features.

Volumetric gratings can be made directly in the waveguide material or made from different material(s) located on the waveguide surface or a combination thereof. Volumetric gratings can have a sinusoidal profile, or multiple sinusoidal profiles with the same surface period but different spatial periods (also known as superimposed or multi-exposed volumetric grating). Volumetric gratings can be made by two-beam interferometric recording, multi-beam interferometric recording, sequential recording of series of two-beams exposure, one-beam contact copying from the master-grating, sequential recording of a series of one-beam contact copying, or other suitable production technique.

Diffractive features of volumetric gratings include high-index regions periodically arranged in a low-index material. Strategies for controlling the diffraction efficiency of volumetric gratings include varying the thickness, the refractive index contrast of the high-index regions and the surrounding low-index material, or the tilt or shape of the high-index regions.

The thickness of low-index layer 208 is greater than 0.01 mm, or greater than 0.05 mm, or greater than 0.1 mm, or greater than 0.2 mm, or greater than 0.4 mm, or greater than 0.6 mm, or greater than 0.8 mm, or greater than 1.0 mm, or greater than 1.2 mm, or greater than 1.4 mm, or less than 6.0 mm, or less than 5.0 mm, or less than 4.0 mm, or less than 3.0 mm, or less than 2.0 mm, or less than 1.0 mm, or in the range from 0.01 mm to 6.0 mm, or in the range from 0.01 mm to 4.0 mm, or in the range from 0.01 mm to 2.0 mm, or in the range from 0.05 mm to 6.0 mm, or in the range from 0.05 mm to 4.0 mm, or in the range from 0.05 mm to 2.0 mm, or in the range from 0.1 mm to 2.0 mm, or in the range from 0.2 mm to 1.8 mm, or in the range from 0.3 mm to 1.6 mm, or in the range from 0.4 mm to 1.4 mm, or in the range from 0.5 mm to 1.2 mm, or in the range from 0.6 mm to 1.0 mm, or in the range from 0.1 mm to 6.0 mm, or in the range from 0.2 mm to 5.0 mm, or in the range from 0.3 mm to 4.0 mm.

The thickness of high-index layer 206 is greater than 0.01 mm, or greater than 0.05 mm, or greater than 0.1 mm, or greater than 0.2 mm, or greater than 0.4 mm, or greater than 0.6 mm, or greater than 0.8 mm, or greater than 1.0 mm, or greater than 1.2 mm, or greater than 1.4 mm, or less than 4.0 mm, or less than 3.5 mm, or less than 3.0 mm, or less than 2.5 mm, or less than 2.0 mm, or less than 1.5 mm, or in the range from 0.01 mm to 4.0 mm, or in the range from 0.05 mm to 3.5 mm, or in the range from 0.1 mm to 3.0 mm, or in the range from 0.2 mm to 2.5 mm, or in the range from 0.3 mm to 2.0 mm, or in the range from 0.4 mm to 1.5 mm, or in the range from 0.5 mm to 1.3 mm.

When configured as a surface relief grating or a metasurface, the thickness of high-index diffraction grating layer 212 is greater than 5 nm, or greater than 10 nm, or greater than 20 nm, or greater than 30 nm, or greater than 40 nm, or greater than 50 nm, or in the range from 5 nm to 100 nm, or in the range from 10 nm to 70 nm, or in the range from 15 nm to 50 nm, or in the range from 20 nm to 40 nm.

When configured as a volumetric grating, the thickness of high-index diffraction grating layer 212 is greater than 0.5 μm, or greater than 1.0 μm, or greater than 2.5 μm, or greater than 5.0 μm, or greater than 7.5 μm, or greater than 10.0 μm, or greater than 12.5 μm, or greater than 15.0 μm, or greater than 17.5 μm, or greater than 20.0 μm, or in the range from 0.5 μm to 25.0 μm, or in the range from 0.5 μm to 25.0 μm, or in the range from 1.0 μm to 20.0 μm, or in the range from 2.5 μm to 17.5 μm, or in the range from 5.0 μm to 15.0 μm.

The thickness of low-index spacer layer 214, when present, is greater than 50 nm, or greater than 100 nm, or greater than 300 nm, or greater than 500 nm, or greater than 700 nm, or greater than 1000 nm, or in the range from 50 nm to 2000 nm, or in the range from 100 nm to 1500 nm, or in the range from 200 nm to 1000 nm, or in the range from 300 nm to 800 nm, or in the range from 400 nm to 700 nm. In embodiments, low-index spacer layer 214 is absent and high-index diffraction grating layer 212 is in direct contact with low-index diffraction grating layer 216.

When configured as a surface relief grating or a metasurface, the thickness of low-index diffraction grating layer 216 is greater than 50 nm, or greater than 100 nm, or greater than 150 nm, or greater than 200 nm, or greater than 250 nm, or greater than 300 nm, or greater than 350 nm, or greater than 400 nm, or in the range from 50 nm to 500 nm, or in the range from 100 nm to 450 nm, or in the range from 150 nm to 400 nm, or in the range from 200 nm to 350 nm.

When configured as a volumetric grating, the thickness of low-index diffraction grating layer 216 is greater than 0.5 μm, or greater than 1.0 μm, or greater than 2.5 μm, or greater than 5.0 μm, or greater than 7.5 μm, or greater than 10.0 μm, or greater than 12.5 μm, or greater than 15.0 μm, or greater than 17.5 μm, or greater than 20.0 μm, or in the range from 0.5 μm to 25.0 μm, or in the range from 0.5 μm to 25.0 μm, or in the range from 1.0 μm to 20.0 μm, or in the range from 2.5 μm to 17.5 μm, or in the range from 5.0 μm to 15.0 μm.

Materials for low-index layer 208, high-index layer 206, high-index diffraction grating layer 212, low-index spacer layer 214, and low-index diffraction grating layer 216 are not limited. Representative materials for each include glasses, crystals, and polymers. Glasses include silicates, borates, and phosphates. Crystals include metal oxides and metal fluorides. The main requirement is optical transparency at the wavelength of the light guided in waveguide 205. Optical transparency of a wavelength requires that less than 10%, or less than 5%, or less than 1%, or less than 0.5%, or less than 0.1% of the intensity of the wavelength is absorbed per millimeter of optical path length. Preferred wavelengths for augmented reality applications and virtual images are visible wavelengths (400 nm to 700 nm). In one embodiment, low-index layer 208 and low-index diffraction grating layer 216 comprise or consist of the same material. In another embodiment, low-index spacer layer 214 and low-index diffraction grating layer 216 comprise or consist of the same material. In still another embodiment, high-index layer 206 and high-index diffraction grating layer 212 comprise or consist of the same material.

The refractive index n₅₃₂ for low-index layer 208, high-index layer 206, high-index diffraction grating layer 212, low-index spacer layer 214, and low-index diffraction grating layer 216 are not limited. Materials with refractive index n₅₃₂ in the range from 1.2 to 5.0, or in the range from 1.4 to 4.5, or in the range from 1.6 to 4.0, or in the range from 1.8 to 3.5, or in the range from 2.0 to 3.0 can be used for low-index layer 208, high-index layer 206, high-index diffraction grating layer 212, low-index spacer layer 214, and low-index diffraction grating layer 216.

One requirement is for the refractive index n₅₃₂ for high-index layer 206 to be greater than the refractive index n₅₃₂ of low-index layer 208. The difference between the refractive index n₅₃₂ of high-index layer 206 and the refractive index n₅₃₂ of low-index layer 208 establishes the conditions for total internal reflection in waveguide 205. The absolute value of the difference between the refractive index n₅₃₂ for high-index layer 206 and the refractive index n₅₃₂ of low-index layer 208 is greater than or equal to 0.1, or greater than or equal to 0.2, or greater than or equal to 0.3, or greater than or equal to 0.5, or greater than or equal to 0.7, or greater than or equal to 0.9, or greater than or equal to 1.2, or greater than or equal to 1.5, or in the range from 0.1 to 2.0, or in the range from 0.2 to 1.8, or in the range from 0.3 to 1.5, or in the range from 0.4 to 1.2, or in the range from 0.5 to 1.0.

A second requirement is for the refractive index n₅₃₂ for high-index diffraction grating layer 212 to be greater than the refractive index n₅₃₂ of low-index diffraction grating layer 216. The difference between the refractive index n₅₃₂ of high-index diffraction grating layer 212 and the refractive index n₅₃₂ of low-index diffraction grating layer 214 establishes the conditions for total internal reflection in high-index layer 206 of waveguide 205 and acts to inhibit transmission of diffracted light 230 to low-index grating layer 216. The absolute value of the difference between the refractive index n₅₃₂ for high-index diffraction grating layer 212 and the refractive index n₅₃₂ of low-index diffraction grating layer 216 is greater than or equal to 0.1, or greater than or equal to 0.3, or greater than or equal to 0.5, or greater than or equal to 0.7, or greater than or equal to 0.9, or greater than or equal to 1.2, or greater than or equal to 1.5, or in the range from 0.1 to 2.0, or in the range from 0.2 to 1.8, or in the range from 0.3 to 1.5, or in the range from 0.4 to 1.2, or in the range from 0.5 to 1.0.

A third requirement is for the refractive index n₅₃₂ for high-index diffraction grating layer 212 to be greater than the refractive index n₅₃₂ of low-index spacer layer 214. The difference between the refractive index n₅₃₂ of high-index diffraction grating layer 212 and the refractive index n₅₃₂ of low-index spacer layer 214 establishes the conditions for total internal reflection in high-index layer 206 of waveguide 205 and acts to inhibit transmission of diffracted light 230 to low-index diffraction grating layer 216. The absolute value of the difference between the refractive index n₅₃₂ for high-index diffraction grating layer 212 and the refractive index n₅₃₂ of low-index diffraction grating layer 216 is greater than or equal to 0.1, or greater than or equal to 0.3, or greater than or equal to 0.5, or greater than or equal to 0.7, or greater than or equal to 0.9, or greater than or equal to 1.2, or greater than or equal to 1.5, or in the range from 0.1 to 2.0, or in the range from 0.2 to 1.8, or in the range from 0.3 to 1.5, or in the range from 0.4 to 1.2, or in the range from 0.5 to 1.0.

In a preferred embodiment, the refractive index n₅₃₂ of low-index layer 208 is equal to similar to the refractive index n₅₃₂ of low-index diffraction grating layer 216. The absolute value of the difference between the refractive index n₅₃₂ for low-index layer 208 and the refractive index n₅₃₂ of low-index diffraction grating layer 216 is less than or equal to 0.5, or less than or equal to 0.4, or less than or equal to 0.3, or less than or equal to 0.2, or less than or equal to 0.1, or equal to 0.0, or in the range from 0.0 to 0.5, or in the range from 0.0 to 0.4, or in the range from 0.0 to 0.3, or in the range from 0.0 to 0.2, or in the range from 0.0 to 0.1.

In a preferred embodiment, the refractive index n₅₃₂ of low-index layer 208 is equal to or similar to the refractive index n₅₃₂ of low-index spacer layer 214. The absolute value of the difference between the refractive index n₅₃₂ for low-index layer 208 and the refractive index n₅₃₂ of low-index spacer layer 214 is less than or equal to 0.5, or less than or equal to 0.4, or less than or equal to 0.3, or less than or equal to 0.2, or less than or equal to 0.1, or equal to 0.0, or in the range from 0.0 to 0.5, or in the range from 0.0 to 0.4, or in the range from 0.0 to 0.3, or in the range from 0.0 to 0.2, or in the range from 0.0 to 0.1.

In a preferred embodiment, the refractive index n₅₃₂ of high-index layer 206 is equal to or similar to the refractive index n₅₃₂ of high-index diffraction grating layer 212. The absolute value of the difference between the refractive index n₅₃₂ for high-index layer 206 and the refractive index n₅₃₂ of high-index diffraction grating layer 212 is less than or equal to 0.5, or less than or equal to 0.4, or less than or equal to 0.3, or less than or equal to 0.2, or less than or equal to 0.1, or equal to 0.0, or in the range from 0.0 to 0.5, or in the range from 0.0 to 0.4, or in the range from 0.0 to 0.3, or in the range from 0.0 to 0.2, or in the range from 0.0 to 0.1.

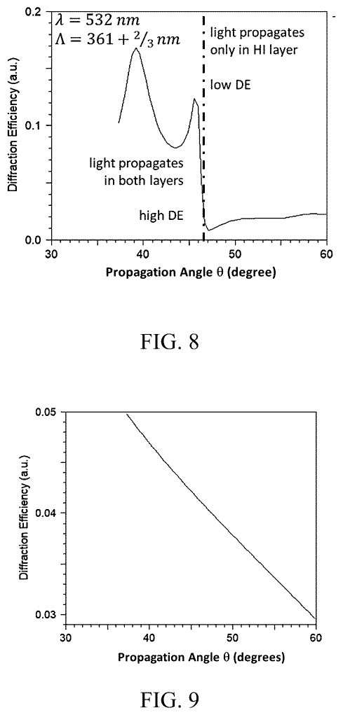

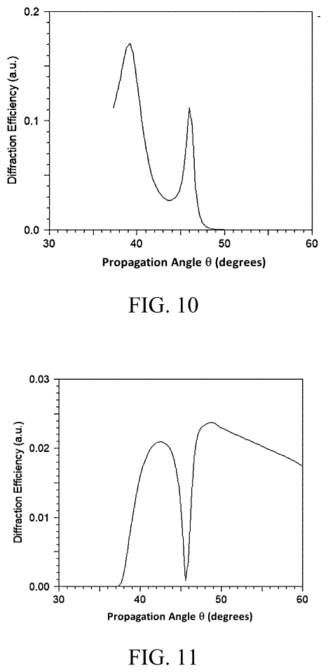

FIGS. 9-11 show plots of modelled diffraction efficiency (DE₅₃₂) as a function of propagation angle θ for comparative examples that deviate from the optical element 200 shown in FIG. 7 by excluding one of the diffraction grating layers. Each of the comparative examples included waveguide 205 with high-index layer 206, low-index layer 208, in-coupling grating 110 and spacing between in-coupling grating 110 and an out-coupling grating as described above in connection with FIG. 8. The comparative examples differ in the configuration of the out-coupling grating. For the comparative example with the diffraction efficiency depicted in FIG. 9, the out-coupling grating included only high-index diffraction grating layer 212 (as described above in connection with FIG. 8) and excluded both low-index spacer layer 214 and low-index diffraction grating layer 216. For the comparative example with the diffraction efficiency depicted in FIG. 10, the out-coupling grating included both low-index spacer layer 214 and low-index diffraction grating layer 216 (as described above in connection with FIG. 8) and excluded high-index diffraction grating layer 212. For the comparative example with the diffraction efficiency depicted in FIG. 11, the out-coupling grating included high-index diffraction grating layer 212 and low-index spacer layer 214 (as described above in connection with FIG. 8) and excluded low-index diffraction grating layer 216. The performance of the comparative examples is inferior to the embodiment described above with an out-coupling grating that included two diffraction grating layers. The comparative examples depicted in FIGS. 9 and 11 exhibit poor diffraction efficiency and lack an approximately constant diffraction efficiency at high propagation angle needed to better equalize brightness over an expanded range of incidence angles. The comparative example depicted in FIG. 10 exhibits zero diffraction efficiency for propagation angles above about 49° and thus excludes a wide range of incidence angles from the output light used to form a virtual image.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or description that the steps are to be limited to a specific order, it is no way intended that any particular order be inferred.

It will be apparent to those skilled in the art that various modifications and variations can be made without departing from the spirit or scope of the illustrated embodiments. Since modifications, combinations, sub-combinations, and variations of the disclosed embodiments that incorporate the spirit and substance of the illustrated embodiments may occur to persons skilled in the art, the description should be construed to include everything within the scope of the appended claims and their equivalents.

What is claimed is:

1. An optical element comprising
a waveguide, the waveguide comprising a first layer in contact with a substrate, the first layer having a first refractive index n_{532,1} and the substrate having a second refractive index n_{532,2}, the first refractive index n_{532,1} greater than the second refractive index n_{532,2};
a diffractive optical element in contact with the waveguide, the waveguide directing light to the diffractive optical element at a first propagation angle θ, the diffractive optical element comprising:
a first diffraction grating layer in contact with the first layer, the first diffraction grating layer having a third refractive index n_{532,3} and a first diffraction efficiency DE_{532,1} at the first propagation angle θ, the third refractive index n_{532,3} greater than the second refractive index n_{532,2};
a second diffraction grating layer in contact with the first diffraction grating layer, the second diffraction grating layer having a fourth refractive index n_{532,4} and a second diffraction efficiency DE_{532,2} at the first propagation angle θ, the fourth refractive index n_{532,4} less than the third refractive index n_{532,3}, the second diffraction efficiency DE_{532,2} greater than the first diffraction efficiency DE_{532,1}.

2. The optical element of claim 1, wherein the absolute value of the difference between first refractive index n_{532,1} and the second refractive index n_{532,2} is greater than or equal to 0.2.

3. The optical element of claim 1, wherein the first diffractive grating layer is in direct contact with the first layer of the waveguide.

4. The optical element of claim 1, wherein the absolute value of the difference between third refractive index n_{532,3} and the second refractive index n_{532,2} is greater than or equal to 0.2.

5. The optical element of claim 1, wherein the absolute value of the difference between third refractive index n_{532,3} and the first refractive index n_{532,1} is less than or equal to 0.2.

6. The optical element of claim 1, wherein the second diffraction grating layer is in indirect contact with the first layer of the waveguide.

7. The optical element of claim 1, wherein the absolute value of the difference between third refractive index n_{532,3} and the fourth refractive index n_{532,4} is greater than or equal to 0.2.

8. The optical element of claim 1, wherein the absolute value of the difference between fourth refractive index n_{532,4} and the second refractive index n_{532,2} is less than or equal to 0.2.

9. The optical element of claim 1, wherein the absolute value of the difference between the second diffraction efficiency DE_{532,2} and the first diffraction efficiency DE_{532,1} is greater than 10%.

10. The optical element of claim 1,
wherein the waveguide is configured to receive light over a field of view defined by a first angular range, the first angular range comprising a plurality of incidence angles α extending from a minimum incidence angle αₘᵢₙ to a maximum incidence angle αₘₐₓ, the plurality of incidence angles including a first interval of incidence angles extending from the minimum incidence angle αₘᵢₙ to a first intermediate incidence angle α₁ and a second interval of incidence angles extending from a second intermediate incidence angle α₂ to the maximum incidence angle αₘₐₓ; and
wherein the light with the first interval of incidence angles is transmitted by total internal reflection in the substrate and first layer of the waveguide.

11. The optical element of claim 10, wherein the optical element is configured such that the light with the first interval of incidence angles is diffracted by the first diffraction grating layer and the second diffraction grating layer.

12. The optical element of claim 10, wherein the light with the second interval of incidence angles is transmitted by total internal reflection in the first layer of the waveguide and not in the substrate.

13. The optical element of claim 12, wherein the optical element is configured such that the light with the second interval of incidence angles is diffracted by the first diffraction grating layer but not the second diffraction grating layer.

14. The optical element of claim 10, wherein the waveguide directs the light with the first interval of incidence angles to the diffractive optical element over a range of propagation angles, the range of propagation angles comprising the first propagation angle θ.

15. The optical element of claim 10, wherein the diffractive optical element exhibits a discontinuous change in diffraction efficiency (DE₅₃₂) over a range of incidence angles α extending from the first intermediate incidence angle α₁ to the second intermediate incidence angle α₂.

16. The optical element of claim 15, wherein the discontinuous change comprises a decreases in diffraction efficiency (DE₅₃₂) from the first diffraction efficiency DE_{532,1} at the first intermediate incidence angle α₁ to the second diffraction efficiency DE_{532,2} at the second intermediate incidence angle α₂.

17. The optical element of claim 15, wherein the difference between the second intermediate incidence angle α₂ and the first intermediate incidence angle α₁ is less than or equal to 3.0°.

18. The optical element of claim 1, further comprising a spacer layer between the first diffraction grating layer and the second diffraction grating layer, the spacer layer lacking diffractive features and having a fifth refractive index n_{532,5}, the fifth refractive index n_{532,5} less than the third refractive index n_{532,3}.

19. The optical element of claim 18, wherein the thickness of the spacer layer is greater than the thickness of the second diffraction grating layer.

20. The optical element of claim 1, further comprising an in-coupling element in contact with the waveguide, the in-coupling element configured to receive imaging light and to direct the imaging light to the diffractive optical element by total internal reflection through the waveguide.
